(19) United States
(12) Patent Application Publication
(10) Pub. No.: US 2021/0095929 A1
(43) Pub. Date: Apr. 1, 2021

(54) RECIRCULATION FLOW-LOOP BATCH REACTOR WITH EXTERNAL HEAT EXCHANGER

(71) Applicant: SOCIETE DES PRODUITS NESTLE S.A., Vevey (CH)

(72) Inventor: Constantine Sandu, Solon, OH (US)

(21) Appl. No.: 17/044,690

(22) PCT Filed: Apr. 18, 2019
(86) PCT No.: PCT/EP2019/060071

§ 371 Date: Oct. 1, 2020

Related U.S. Application Data
(60) Provisional application No. 62/686,761, filed on Jun. 19, 2018.

(51) Int. Cl. F28D 15/02; F28F 27/00

(52) U.S. Cl. CPC F28D 15/0266; F28D 7/106; F28F 27/00

(57) ABSTRACT

The present invention relates to a batch reactor system designed to conduct heat-induced food-processing transformations. Particularly, the invention describes a Recirculation Flow-Loop Batch (RFLB) Reactor for conducting high-temperature transformations, preferably at short conversion times, which involve non-Newtonian high-viscosity formulations, where the reactants are preferably natural food ingredients. The invention further relates to a method for reducing burn-on effects of ingredients of the formulation when heated and cooled in a RFLB reactor.

The present invention relates to a batch reactor system designed to conduct heat-induced food-processing transformations. Particularly, the invention describes a Recirculation Flow-Loop Batch (RFLB) Reactor for conducting high-temperature transformations, preferably at short conversion times, which involve non-Newtonian high-viscosity formulations, where the reactants are preferably natural food ingredients. The invention further relates to a method for reducing burn-on effects of ingredients of the formulation when heated and cooled in a RFLB reactor.

Reactors for heating and cooling high-viscosity formulations such as food compositions have long been used for different purposes in the food industry and are known in the prior art. One such example has been described in U.S. Pat. No. 5,589,214, where particulate food material is heat treated in a cylindrical vessel under vacuum and agitation, while steam is injected.

The design and set-up of such a batch reactor system with its heating and cooling system is very critical when it comes to optimize efficiency of product through-put and quality of the food-processing reaction. In order to optimize such industrial processes, heating and cooling of such high-viscosity food formulations, which behave in such reaction systems as non-Newtonian fluids, should be fast in order to reduce the overall time needed for a one batch process. The longer the heating and the cooling of a formulation takes in a batch process, the longer the overall transformation process takes and the longer the reactor system will be occupied per batch. For industrial efficiency, it is of advantage and highly desirable to shorten the time needed for an individual batch process, in order to increase the number of times a reactor system can be used within a certain time period. It provides a better return on investment and production efficiency of such a complex and expensive reactor system.

Furthermore, fast heating and fast cooling allows to better control the high-temperature transformation reaction as the fluid food material does not persist in the reactor system for a prolonged time at intermediate temperatures. The time of the high-temperature reaction can be more precisely set and controlled, because the high-viscosity fluid product is rapidly brought to the desired reaction temperature and thereafter rapidly cooled again to stop any further follow-up reactions.

Furthermore, it is known in the art that rapid heating in a reactor system has the disadvantage that particularly food materials will stick to heat transfer surfaces which are hot and thereby lead to burning effects and fouling of the high-viscosity fluid material. This is not desired and often forces the operator of such an installation to reduce the speed of heating the fluid material in the reactor system. Systems to reduce such burn-on effects typically used are scrappers or other physical installations within the reactor system. Very often, however, they are not very efficient.

Hence, there is still a persisting need in the industry to find alternative reactor systems for rapid heating and cooling non-Newtonian high-viscosity fluids such as e.g. complex food compositions.

The object of the present invention is to improve the state of the art and to overcome at least some of the inconveniences described above.

One object of the present invention is to provide a new solution and method for reducing or preventing burn-on effects when rapid heating and cooling a non-Newtonian high-viscosity fluid in a batch reactor system.

One other object of the present invention is to provide a new batch reactor apparatus for rapid heating and cooling of non-Newtonian high-viscosity fluids, particularly in such a way as to reduce or eliminate burn-on effects of the fluids.

The object of the present invention is achieved by the subject matter of the independent claims. The dependent claims further develop the idea of the present invention.

Accordingly, the present invention provides in a first aspect a recirculation flow-loop batch reactor for heating and cooling a non-Newtonian high-viscosity fluid comprising:
a reaction vessel,
a recirculation flow-loop connected to the reaction vessel for recirculating the non-Newtonian fluid from the reaction vessel,
a reflux condenser connected to the reaction vessel for evaporative cooling of the non-Newtonian fluid,
two independent heating and cooling dispositions,
a process control unit;
   wherein one independent heating and cooling disposition is coupled to the reaction vessel and one other independent heating and cooling disposition is coupled to the recirculation flow-loop;

wherein the process control unit regulates the two independent heating and cooling dispositions in such a way that a temperature differential between the non-Newtonian fluid and the inner wall of the reaction vessel is below 10° C. at any time during the heating and cooling of the non-Newtonian fluid.

In a second aspect, the invention pertains to a method for reducing burn-on effects when heating and cooling a non-Newtonian high-viscosity fluid in a reactor, comprising the step of heating and cooling the non-Newtonian fluid in a recirculation flow-loop batch reactor, where a process control unit regulates two independent heating and cooling dispositions in such a way that a temperature differential between the non-Newtonian fluid and the inner wall of a reaction vessel is below 10° C. at any time during the heating and cooling of the non-Newtonian fluid.

It has been surprisingly found by the inventors that when a recirculation flow-loop batch (RFLB) reactor is equipped and designed with two independent heating and cooling dispositions in such a way that a temperature differential between the non-Newtonian fluid and the inner wall of a reaction vessel is below 10° C. at any time during the heating and cooling of the non-Newtonian fluid composition present in the reaction vessel, heating and cooling of the fluid can be much accelerated without having the effect of burn-on of the fluid in the reactor.

In particular, the inventors have now designed a RFLB Reactor as an integrated-unit-operations equipment, preferably for high-temperature and optionally high-pressure transformations, which optimizes the chemical reaction kinetics in association with the momentum, heat, and mass transfer. The RFLB Reactor of the present invention allows now for a better control of the extent of chemical reactions and chemical transformations.

Particularly, the inventors have found that the RFLB Reactor of the present invention allows minimizing the rate of burn-on at the heat transfer surfaces; where burn-on contributes to bitter and off-flavour products, including carcinogenic products, typically associated with Maillard Reactions. Generation of such burn-on products of reaction is extensive enough in most known prior art reactors, if the temperature of the heat transfer surface is above 180°C, and this even when the bulk average temperature of the fluid food product is significantly below 180° C.

The RFLB Reactor of the present invention now allows for high heating and cooling rates of non-Newtonian high-viscosity fluid formulations, based on the concept of separate heating/cooling loads for both the mass of the product inside the reactor and the mass of the metal associated with the reactor (including the external heat exchanger). An advanced process control allows simultaneously heating/cooling the fluid product and the metal of the reaction vessel, on target temperature-vs.-time profiles. Furthermore, the RFLB Reactor allows for precise process control of both the heating/cooling rates and the temperature gradients at the metal inner wall surfaces of the reactor, implicitly minimizing the heating/cooling-induced mechanical stresses in the reactor.

### BRIEF DESCRIPTION OF THE DRAWINGS

FIG. 1: Example of a Recirculation Flow-Loop Batch Reactor according to the present invention.

FIG. 2: Temperature profile of a run in a RFLB reactor of the present invention.

### DETAILED DESCRIPTION OF THE INVENTION

The present invention pertains in a first aspect to a recirculation flow-loop batch reactor for heating and cooling a non-Newtonian high-viscosity fluid comprising:
a reaction vessel,
a recirculation flow-loop connected to the reaction vessel for recirculating the non-Newtonian fluid from the reaction vessel,
a reflux condenser connected to the reaction vessel for evaporative cooling of the non-Newtonian fluid,
two independent heating and cooling dispositions,
a process control unit;

wherein one independent heating and cooling disposition is coupled to the reaction vessel and one other independent heating and cooling disposition is coupled to the recirculation flow-loop;

wherein the process control unit regulates the two independent heating and cooling dispositions in such a way that a temperature differential between the non-Newtonian fluid and the inner wall of the reaction vessel is below 10° C. at any time during the heating and cooling of the non-Newtonian fluid.

In order to further minimize the risk of burn-on effects, embodiments of the present invention pertain to the recirculation flow-loop batch reactor according to claim 1, wherein the temperature differential between the non-Newtonian fluid and the inner wall of the reaction vessel is below 8° C., preferably below 6° C., preferably below 4° C. or even more preferably below 2° C., at any time during the heating and cooling of the non-Newtonian fluid. The smaller the temperature differential, the smaller the risk of burn-on effects which potentially could generate off-flavors, off colors or other undesired reaction products of the fluid.

A recirculation flow-loop batch (RFLB) reactor is a reactor having a flow-loop for recirculating the fluid inside the reactor through the flow-loop.

A non-Newtonian fluid as of the present invention is a fluid which has a flow behavior index of smaller than 1. The high-viscosity of the non-Newtonian fluid is defined herein by the flow consistency factor K. Preferably, this flow consistency factor K of the fluid is at least 10 [Pa sⁿ] at a temperature of 25° C. More preferably, K is at least 12 [Pa sⁿ] at a temperature of 25° C. Typically, K is not larger than 400 [Pa sⁿ] at a temperature of 25° C.

In one embodiment of the present invention, the non-Newtonian high-viscosity fluid is characterized by a flow behavior index n<1, and a flow consistency factor K from 10 to 400 [Pa sⁿ] at a temperature of 25° C. In a further preferred embodiment, the non-Newtonian high-viscosity fluid is characterized by a flow behavior index n<0.7, and a flow consistency factor K from 12 to 200 [Pa sⁿ] at a temperature of 25° C. In an even more preferred embodiment, the non-Newtonian high-viscosity fluid is characterized by a flow behavior index n<0.5, and a flow consistency factor K from 15 to 200 [Pa sⁿ] at a temperature of 25° C.

In one preferred embodiment of the present invention, the non-Newtonian high-viscosity fluid is a food composition. The food composition may comprise tomato products, other vegetable products, fruit products, meat products, plant and animal based eatable oils and fats, herbs and spices, salts, sugars, taste enhancers, and any combinations thereof. Preferably, the food composition comprises food ingredients selected from the list of tomato sauce, tomato paste, onion purée, meat slurry, vegetable oil, and combinations thereof.

The recirculation flow-loop batch reactor of the present invention comprises an independent heating and cooling disposition coupled to the reaction vessel. In a preferred embodiment, this independent heating and cooling disposition is a thermal fluid heat exchanger. Preferably, this thermal fluid heat exchanger comprises a jacket around the reaction vessel, the jacket through which a heating or cooling fluid can be circulated. Such a fluid can be for example water or a mineral oil.

Furthermore, the recirculation flow-loop batch reactor according to the present invention comprises another independent heating and cooling disposition which is coupled to the recirculation flow-loop. Preferably, this other independent heating and cooling disposition is a heat exchanger, a direct steam injector or an ohmic heater. For example, the recirculation flow-loop may have a jacket around a part of the length of the flow-loop, through which a heating or cooling fluid can be circulated.

The recirculation flow-loop batch reactor of the present invention comprises a process control unit which regulates the two independent heating and cooling dispositions in such a way that a maximum temperature differential between the non-Newtonian fluid and the inner wall of the reaction vessel can be fixed. This maximum temperature differential can be set by the process control unit in such way that it is not exceeded during rapid heating and/or cooling of the fluid during the entire reaction process. Typically, such a process control unit is an electric device, linked or controlled by a computing device.

In one embodiment of the present invention, the heating and cooling of the non-Newtonian fluid in the recirculation flow-loop is by forced convection. Preferably, the non-Newtonian fluid in the recirculation flow-loop has a velocity to induce a wall shear stress of at least 1.0 N m⁻², preferably of at least 1.3 N m⁻², more preferably of at least 1.6 N m⁻².

In one other embodiment of the present invention, the reaction vessel of the recirculation flow-loop batch reactor is designed as a vapor separator. Thereby in a particular embodiment, the recirculation flow-loop is connected to the reaction vessel in such a way that the non-Newtonian fluid returning from the recirculation flow-loop enters the reaction vessel tangentially. This design of the batch reactor has the effect that the non-Newtonian fluid enters the reaction vessel tangentially, flowing along the inner wall of the reactor in a thin film and rotating inside the reactor in a thin film covering the inner wall of the reactor. A mass transfer from the non-Newtonian fluid inside the reactor vessel is thereby optimized for an easy escape of the water vapor into the large headspace provided by the reactor vessel.

In a second aspect, the invention pertains to a method for reducing burn-on effects when heating and cooling a non-Newtonian high-viscosity fluid in a reactor, the method comprising the step of heating and cooling the non-Newtonian fluid in a recirculation flow-loop batch reactor, where a process control unit regulates two independent heating and cooling dispositions in such a way that a temperature differential between the non-Newtonian fluid and the inner wall of a reaction vessel is below 10° C. at any time during the heating and cooling of the non-Newtonian fluid.

Preferably, the temperature differential between the non-Newtonian fluid and the inner wall of the reaction vessel is below 8° C., preferably below 6° C., below 4° C. or even below 2° C., at any time during the heating and cooling of the non-Newtonian fluid.

In one embodiment, the method for reducing burn-on effects when heating and cooling a non-Newtonian high-viscosity fluid in a reactor, the method comprising the step of heating and cooling a non-Newtonian fluid in a recirculation flow-loop batch reactor according to the present invention.

In a preferred embodiment, the heating in the method of the present invention is from 25° C. to 150° C. or above, and the cooling is from 150° C. or above to 25° C. or below. More preferably, the heating is from 20° C. to 175° C. or above, and the cooling is from 175° C. or above to 20° C. or below.

In a further preferred embodiment of the method of the present invention, the heating is achieved within 60 minutes, preferably within 45 minutes, more preferably within 30 minutes. The cooling is preferably achieved within 60 minutes, preferably within 45 minutes, more preferably within 30 minutes.

Those skilled in the art will understand that they can freely combine all features of the present invention disclosed herein. In particular, features described for the apparatus of the present invention may be combined with the method of the present invention and vice versa. Further, features described for different embodiments of the present invention may be combined. Still further advantages and features of the present invention are apparent from the figures and examples.

### Example 1

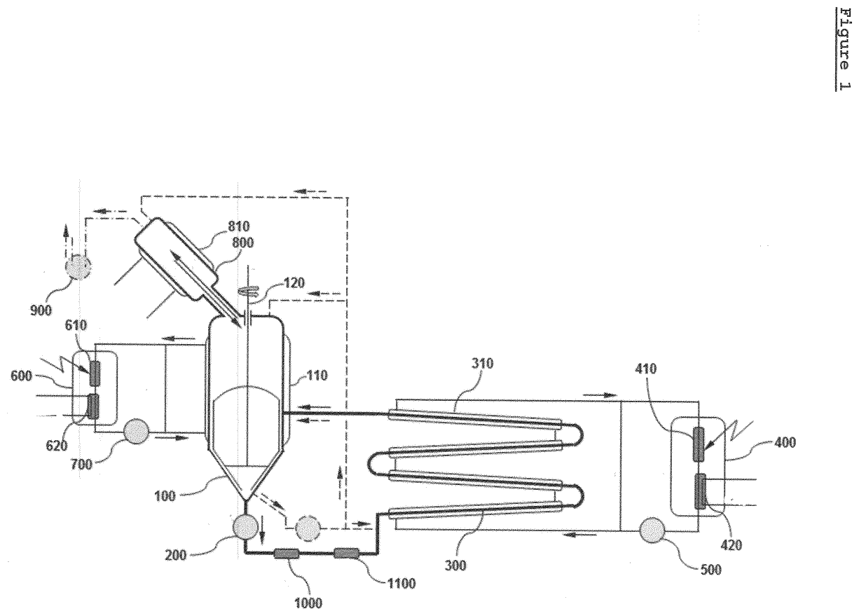

A first working example of a Recirculation Flow-Loop Batch (RFLB) Reactor as of the present invention is demonstrated in FIG. 1. Particularly, the RFLB reactor comprises a reactor vessel and two combined/joined flow-loops, each associated with a required unit operation, wherein each flow-loop consists of a product inlet, a product outlet, and a pumping means for recirculating the product through the given flow-loop; the flow-loops being directly integrated, i.e. physically unified, with the reactor vessel.

With reference to FIG. 1, the first integrated flow-loop is the Recirculation Flow-Loop with the reactor vessel 100 (i.e. product inlet), a main recirculation pump 200, a mass flow-meter 1000, an external heat exchanger 300, and back to the reactor vessel 100 (i.e. product outlet). The primary purpose of the Recirculation Flow-Loop is to provide the energy load to heat up the mass of the product in the reactor vessel, by means of the external heat exchanger 300. Given the high velocities inside the Recirculation Flow-Loop, at any instance, the temperature of the high-viscosity formulation product is about the same in both the reaction vessel 100 and the external heat exchanger 300. The algorithm in the Process Control unit ensures that the agitator-scraper 120 is active while flow is detected in the Recirculation Flow-Loop; the instrumentation that detects flow is the mass flow-meter 1000.

The second integrated flow-loop is the Heat Pipe Flow-Loop with the reactor vessel 100 (as heating-zone or evaporator), a condenser 800 (as cooling zone or condenser), and back to the reactor vessel 100; where a pumping means for the flow of water vapor is provided by a vapor-pressure differential between the evaporator and the condenser; the pumping means for the flow of water condensate from the condenser to the evaporator is provided by gravity. Given the direct contact between them, at any instant, the total pressure is about the same in both the reactor vessel 100 and the condenser 800.

The reactor vessel is designed as a vapor separator, where the liquid formulation returning from the Recirculation Flow-Loop tangentially enters the reactor vessel at high velocity (velocity larger than a minimum required velocity), resulting in a thin film forced by the centrifugal field onto the inside wall of the reactor vessel. Further, the rotation of the thin film is sustained by the agitator-scraper 120, whose tip velocity equals the tangential velocity of the liquid entering the reactor vessel. The thin rotating film allows for an easy mass transfer escape of the water vapor into the large headspace provided by the reactor vessel (above the agitator-scraper 120). The primary purpose of the Heat-Pipe Flow-Loop is to provide the energy load to cool down the mass of the product inside the reactor vessel, by means of the condenser 800.

The process taking place in the Heat-Pipe Flow-Loop equally can be described by the unit operation known as total-reflux evaporative-cooling. Since a total reflux is involved, the Reactor System according to the present invention prevents any losses of volatile aroma compounds, as well as water vapor, throughout the entire Closed-Reactor Cycle. Total reflux occurs during the heating & holding stages, but especially during the cooling stage for which the Heat-Pipe Flow-Loop is defined.

In addition, there are two other flow-loops, associated with the heating and cooling agents (i.e. the utilities) necessary to conduct heating and cooling unit operations. These utility agents flow through the shell 310 of the external heat exchanger 300, respectively, the reactor jacket 110 of the reactor vessel 100. As shown in FIG. 1, there can be three extra locations where cooling glycol is brought to the Reactor System: at the indirect cooler 420, the indirect cooler 620, and the (indirect) condenser 800.

With reference to FIG. 1, the first additional flow-lop is the Zone-One Recirculation Flow-Loop consisting of the zone-one HTF heater-cooler 400, the zone-one recirculation pump 500, the shell 310 of the external heat exchanger 300, and back to the zone-one HTF heater-cooler 400; where HTF stands for High Temperature Fluid of the type commonly known as mineral oils; respectively, the zone-one HTF heater-cooler 400 comprises the electrical heater(s) 410 and the indirect cooler(s) 420. The primary purpose of the Zone-One Recirculation Flow-Loop is to provide the energy load to heat up the mass of the product in the reactor vessel, by means of the external heat exchanger 300. Note that the mass of the metal associated with the Recirculation Flow-Loop is much smaller than the metal mass associated with the reactor vessel, and therefore neglected when it comes to the energy load necessary to heat/cool the metal associated with the external heat exchanger 300.

The second additional flow-lop is the Zone-Two Recirculation Flow-Loop consisting of the zone-two HTF heater-cooler 600, the zone-two recirculation pump 700, the reactor jacket 110 of the reactor vessel 100, and back to the zone-two HTF heater-cooler 600; where the zone-two HTF heater-cooler 600 comprises the electrical heater(s) 610 and the indirect cooler(s) 620. The primary purpose of the Zone-Two Recirculation Flow-Loop is to provide the energy load to cool down the mass of the metal associated with the reactor vessel, by means of the zone-two HTF heater-cooler 600.

In the particular example provided in FIG. 1, the RFLB Reactor according to the present invention features an in-line instrument 1100, installed on the Recirculation Flow-Loop, for monitoring a specific property of the non-Newtonian fluid such as for example pH, color or the presence of any specific molecules. Such a property indicator can be, but is not limited to, a specific product of reaction (monitored by IR Spectroscopy) or the color (monitored by Visible-Light Spectrophotometry).

### Example 2

As an example, the RFLB Reactor of the present invention can be operated under a Temperature-Profile Process Control. This control implies that the operator knows the parameters required to define a target temperature profile.

The following example serves as an illustration: In preparation for a run, the operator knows the initial temperature of the high-viscosity formulation product Tᵢ=10 [°], the heating temperature Tₕ=180 [°], respectively, the cooling temperature T_{c}=10 [°C]. Also, the operator had already transferred the amount of product necessary for a batch m=61 [kg] in the reactor vessel. Also, the operator knows the duration of the holding stage τ_{hold}=6 [min].

Before the start of the heating-holding-cooling cycle, the heating agent in zone-one HTF heater-cooler 400 is brought to the required flow rate w_{1 min}=2 [kg s⁻¹] and temperature t_{1 inlet}=185 [° C.]; these conditions will be maintained constant throughout the heating stage. The heating agent in zone-two HTF heater-cooler 600 is brought to the required flow rate W_{2 min}=2 [kg s⁻¹] and temperature t₂=15 [° C.]; the mass flow rate w_{2 min} will be maintained constant throughout the heating stage. As depicted in FIG. 1, it is possible to bring the heating agents to the required flow-rates and temperatures for the two HTF heater-cooler zones have bypasses that allow internal recirculation, without affecting the state of the reactor vessel.

The operator can start the Recirculation Flow-Loop (RFL) for example at v_{recirc min}=1.5[m s⁻¹], recirculation velocity in the external heat exchanger 300. The product will continuously recirculate through the RFL, at a velocity v_{recirc}≥v_{recirc min}, until the end of the Closed-Reactor Cycle. At the same time, an agitator-scraper 120 can be activated and brought to a tip velocity equal to the velocity v_{recirc} [m s⁻¹] ; the algorithm in the Process Control ensures that the agitator-scraper 120 is active while flow is detected in the Recirculation Flow-Loop; the instrumentation that detects flow is the mass flow-meter 1000.

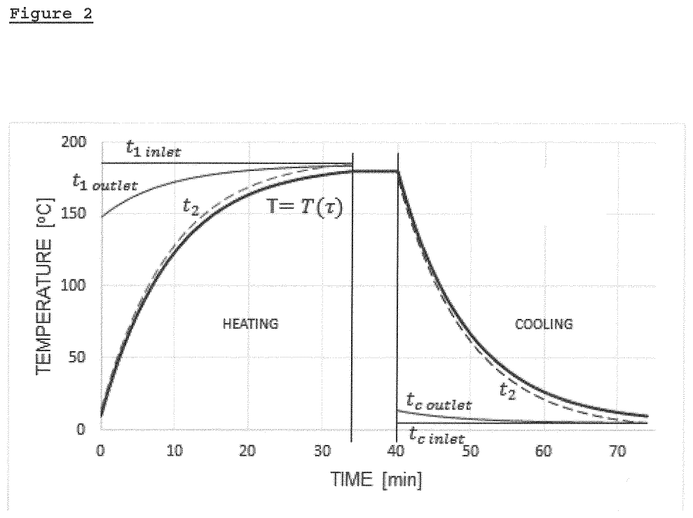

At zero-time, the operator launches the heating stage of the heating-holding-cooling cycle. During the heating stage, the heating agent from zone-one HTF heater-cooler is supplied at constant flow rate w_{1 min}=2 [kg s⁻¹] and constant temperature t_{1 inlet}=185 [°C] to the external heat exchanger 300; necessarily, the heating agent exits the external heat exchanger at the temperature t_{1 outlet}=t_{1 outlet} (τ) as dictated by the heat transfer. Under the given operation conditions, the temperature of the high-viscosity formulation product T=T(τ) follows the profile depicted in FIG. 2. The algorithm in the Process Control ensures the zone-two HTF heater-cooler supplies heating agent at constant flow rate w_{2 min}=2 [kg s⁻¹] and variable temperature t₂=t₂(T) to the jacket 110 of the reactor vessel. Note the small temperature differential between the product inside the reactor vessel and the heating agent in the jacket of the reactor vessel; see FIG. 2.

The duration of the heating stage is the resultant of the heat transfer conditions; with reference to FIG. 2, the heating is accomplished in 34 minutes, at which point the high-viscosity formulation product reaches the heating temperature Tₕ=180 [° C.]. The algorithm in the Process Control launches the holding stage; T_{hold}=6 [min].

During the holding stage, the high-viscosity formulation product is recirculated at v_{recirc min}=1.5 [m s⁻¹]; while the mass flow rates at zone-one HTF heater-cooler w_{1 min}=2 [kg s⁻¹] and zone-two HTF heater-cooler W_{2 min}=2 [kg s⁻¹] are kept constant. The algorithm in the Process Control acts upon temperatures =t₁(τ) and t₂=t₂(τ) at zone-one and zone-two of the HTF heater-cooler to keep the temperature of the product Tₕ=180 [° C.] constant.

At the end of the holding stage (minute 40, FIG. 2), the algorithm in the Process Control launches the cooling stage. The product continues to recirculate at v_{recirc min}=1.5[m s−1]; while the mass flow rates at zone-one HTF heater-cooler w_{1 min}=2 [kg s⁻¹] and zone-two HTF heater-cooler w_{2 min}=2 [kg s⁻¹] are kept constant. Also, the condenser 800 is engaged by allowing flow of cooling glycol at a constant mass flow rate w_{c min}=2 [kg s⁻¹] and a constant temperature t_{c inlet}=5 [° c]. Necessarily, following heat transfer considerations, the temperature of the glycol at the exit from the jacket 810 of the condenser t_{c outlet}=t_{c outlet} (τ) changes through-out the cooling stage; see FIG. 2.

Under the given operation conditions for cooling, the temperature of the high-viscosity formulation product T=T(τ) follows the profile depicted in FIG. 2. The algorithm in the Process Control additionally ensures the zone-one and zone-two of the HTF heater-cooler supply cooling agents at a variable temperature t₂=t₂(T) to the outer shell 310 of the external heat exchanger and the jacket 110 of the reactor vessel. Note the small temperature differential between the product inside the reactor vessel and the cooling agent in the outer shell of the external heat exchanger and the jacket of the reactor vessel; see FIG. 2.

The duration of the cooling stage is the resultant of the heat transfer conditions; with reference to FIG. 2, the cooling is accomplished in 34 minutes, at which point the high-viscosity formulation product reaches the cooling temperature T_{c}=10 [° C.]. The operator stops the Recirculation Flow-Loop (RFL), i.e. v_{recirc min}=0[m s⁻¹], implicitly bringing the agitator-scraper 120 to a halt and the Closed-Reactor Cycle comes to an end; allowing the Reactor System to be discharged.

1. A recirculation flow-loop batch reactor for heating and cooling a non-Newtonian high-viscosity fluid comprising:
a reaction vessel,
a recirculation flow-loop connected to the reaction vessel for recirculating the non-Newtonian fluid from the reaction vessel,
a reflux condenser connected to the reaction vessel for evaporative cooling of the non-Newtonian fluid,
two independent heating and cooling dispositions,
a process control unit;
one independent heating and cooling disposition is coupled to the reaction vessel and one other independent heating and cooling disposition is coupled to the recirculation flow-loop; and
the process control unit regulates the two independent heating and cooling dispositions in such a way that a temperature differential between the non-Newtonian fluid and the inner wall of the reaction vessel is below 10° C. at any time during the heating and cooling of the non-Newtonian fluid.

2. The recirculation flow-loop batch reactor according to claim 1, wherein the temperature differential between the non-Newtonian fluid and the inner wall of the reaction vessel is below 8° C., at any time during the heating and cooling of the non-Newtonian fluid.

3. The recirculation flow-loop batch reactor according to claim 1, wherein the non-Newtonian high-viscosity fluid has a flow behavior index n<1, and a flow consistency factor K from 10 to 400 [Pa sⁿ] at a temperature of 25° C.

4. The recirculation flow-loop batch reactor according to claim 3, wherein the non-Newtonian high-viscosity fluid has a flow behavior index n<0.7, and a flow consistency factor K from 12 to 200 [Pa sⁿ] at a temperature of 25° C.

5. The recirculation flow-loop batch reactor according to claim 3, wherein the non-Newtonian high-viscosity fluid is a food composition.

6. The recirculation flow-loop batch reactor according to claim 5, wherein the non-Newtonian high-viscosity fluid is a food composition comprising food ingredients selected from the group consisting of tomato sauce, tomato paste, onion purée, meat slurry, vegetable oil, and combinations thereof.

7. The recirculation flow-loop batch reactor according to claim 1, wherein the independent heating and cooling disposition coupled to the reaction vessel is a thermal fluid heat exchanger.

8. The recirculation flow-loop batch reactor according to claim 7, wherein the thermal fluid heat exchanger comprises a jacket around the reaction vessel, the jacket through which a heating or cooling fluid can be circulated.

9. The recirculation flow-loop batch reactor according to claim 1, wherein the independent heating and cooling disposition coupled to the recirculation flow-loop is a heat exchanger, a direct steam injector or an ohmic heater.

10. The recirculation flow-loop batch reactor according to claim 9, wherein heating and cooling of the non-Newtonian fluid in the recirculation flow-loop is by forced convection.

11. The recirculation flow-loop batch reactor according to claim 10, wherein the non-Newtonian fluid in the recirculation flow-loop has a velocity to induce a wall shear stress of at least 1.0 N m⁻².

12. The recirculation flow-loop batch reactor according to claim 1, wherein the reaction vessel is designed as a vapor separator.

13. The recirculation flow-loop batch reactor according to claim 12, wherein the recirculation flow-loop is connected to the reaction vessel in such a way that the non-Newtonian fluid returning from the recirculation flow-loop enters the reaction vessel tangentially.

14. A method for reducing burn-on effects when heating and cooling a non-Newtonian high-viscosity fluid in a reactor, comprising the step of heating and cooling the non-Newtonian fluid in a recirculation flow-loop batch reactor, where a process control unit regulates two independent heating and cooling dispositions in such a way that a temperature differential between the non-Newtonian fluid and the inner wall of a reaction vessel is below 10° C. at any time during the heating and cooling of the non-Newtonian fluid.

15. The method according to claim 14, wherein the temperature differential between the non-Newtonian fluid and the inner wall of the reaction vessel is below 8° C., at any time during the heating and cooling of the non-Newtonian fluid.

16. The method according to claim 14, comprising the step of heating and cooling a non-Newtonian fluid in a recirculation flow-loop batch reactor comprising a reaction vessel, a recirculation flow-loop connected to the reaction vessel for recirculating the non-Newtonian fluid from the reaction vessel, a reflux condenser connected to the reaction vessel for evaporative cooling of the non-Newtonian fluid, two independent heating and cooling dispositions, a process control unit, wherein one independent heating and cooling disposition is coupled to the reaction vessel and one other independent heating and cooling disposition is coupled to the recirculation flow-loop, and the process control unit regulates the two independent heating and cooling dispositions in such a way that a temperature differential between the non-Newtonian fluid and the inner wall of the reaction vessel is below 10° C. at any time during the heating and cooling of the non-Newtonian fluid.

17. The method according to claim 14, wherein the heating is from 25° C. to 150° C. or above, and the cooling is from 150° C. or above to 25° C. or below.

18. The method according to claim 14, wherein the heating is from 20° C. to 175° C. or above, and the cooling is from 175° C. or above to 20° C. or below.

19. The method according to claim 14, wherein the heating is achieved within 60 minutes.

20. The method according to claim 14, wherein the cooling is achieved within 60 minutes.
